(19) United States
(12) Patent Application Publication
(10) Pub. No.: US 2006/0220975 A1
(43) Pub. Date: Oct. 5, 2006

(54) Magnetic source oscillators universal passive antenna

(76) Inventor: Codjo Atchiriki, (US)

Correspondence Address: SCHMEISER OLSEN & WATTS, 18 E UNIVERSITY DRIVE, SUITE # 101, MESA, AZ, 85201, US

(21) Appl. No.: 11/330,952

(22) Filed: Jan. 11, 2006

Related U.S. Application Data
(63) Continuation-in-part of application No. 11/100,265, filed on Apr. 5, 2005.

(51) Int. Cl. H01Q 9/16

(52) U.S. Cl. 343/793; 343/878

(57) ABSTRACT

A device concerning the continuation invention of a Magnetic Source Oscillators Universal Passive Antenna to receive or transmit electromagnetic waves from low to hyper frequencies. The device is made with an improved special dipolar system that contains two identical parts (15) and (16). Each identical part (15) or (16) of the special dipolar system is made with a triangular or rectangular magnet (3), a triangular or rectangular semiconductor (4) containing a small conducting edge (5) in case of triangular semiconductor, a capacitor (21) and a pointed conducting cable (7).

A wave-pick-up-system made with two cables (11), (12) and a cable entrance (14), forms together with the special dipolar system the acting principle (1) of the antenna described in FIG. 1 and FIG. 2. The special dipolar system can also be reduced to only one half part (15) according to FIG. 3 and FIG. 4. In these cases, the wave-pick-up-system is made with the cables (11), (12), the cable entrance (14) and an electric mass (20) which physical form can be variable. The acting principle (1) of the antenna described as in FIG. 1, FIG. 2, FIG. 3 or FIG. 4, is then sealed in a filled insulating material box (17) and raised according to FIG. 5, on a tripod (18) that can be very variable and adaptable. The device of the continuation invention is effective in the frequency range from low to hyper frequencies and very effective for satellites communication.

The complete antenna (2) can also be small-scale devised and used as transducer to enhance performances of parabolic antennas.

### BACKGROUND OF THE INVENTION

The present invention is a continuation-in-part to the earlier U.S. utility patent application entitled Magnetic Source Oscillators Universal Passive Antenna, Ser. No. 11/100,265, filed Apr. 5, 2005. The previous invention does not achieve the frequency goal of reaching hyper frequencies with satisfaction. The device of the present invention helps to overcome this disadvantage.

### DISCLOSURE OF THE INVENTION

In a first description, this device is indeed made with an improved acting principle of the antenna described as being made with an improved special dipolar system and a wave-pick-up-system.

In concrete device:

The improved special dipolar system is made with two identical parts. Each identical part of the improved special dipolar system is made with a magnet of triangular or rectangular form, a semiconductor of triangular or rectangular form containing a small conducting edge in case of triangular semiconductor, a capacitor and a pointed conducing cable.

The wave-pick-up-system is made with two electric or coaxial cables which length can be very reduced and a cable entrance.

The acting principle of the antenna made with the special dipolar system and the wave-pick-up-system, is sealed with a filled insulating material box and raised on a tripod support to form the complete antenna.

### BRIEF DESCRIPTION OF THE DRAWINGS

FIG. 1 Represents the acting principle of the transmitting antenna;

FIG. 2 Represents the acting principle of the receiving antenna;

FIG. 3 Represents an accurate variant of previous FIG. 1;

FIG. 4 Represents an accurate variant of previous FIG. 2;

FIG. 5 Represents the complete antenna; and

FIG. 6 Represents a variant of the acting principle (1) of the antenna.

### DETAILED DESCRIPTION OF EMBODIMENTS OF THE INVENTION

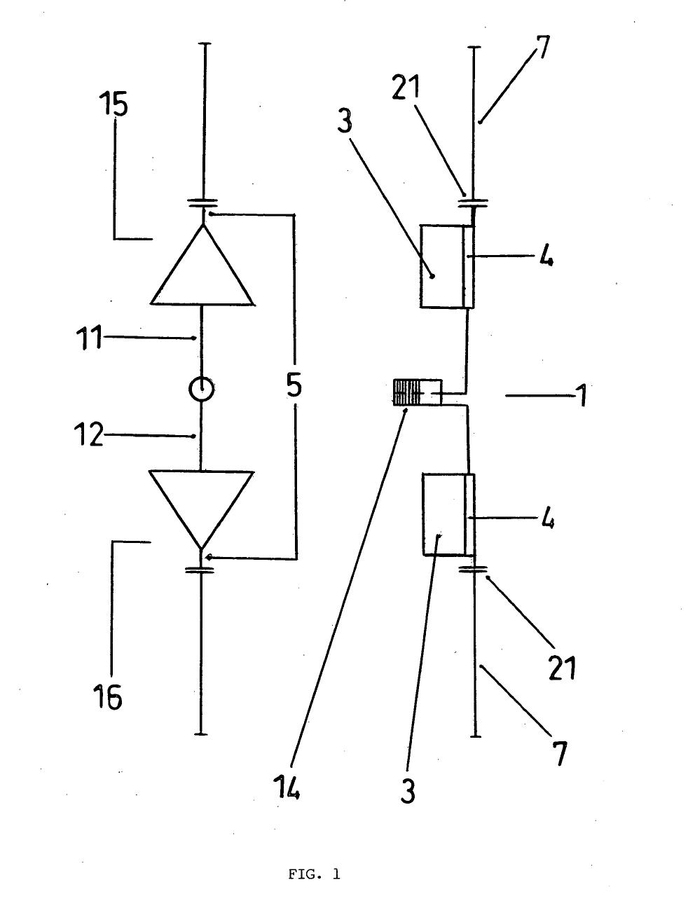

In reference to the figures, the acting principle (1) of the antenna previously described in previous FIG. 1, can be improved according to current FIG. 1, by introducing the capacitors (21) and by remodeling or reshaping the previous metal support (7) (in previous FIG. 1)

In that sense, the improved acting principle (1) is made with an improved special dipolar system containing two identical parts (15) and (16); and a wave-pick-up-system. Each identical part (15) or (16) of the improved special dipolar system is made with:

One triangular or rectangular magnet (3);

One triangular or rectangular semiconductor (4) containing a small conducting edge (5) in case of triangular semiconductor;

One capacitor (21); and

One pointed conducting cable (7).

The wave-pick-up-system is made with:

Two electric or coaxial cables (11) and (12) which length can be very reduced; and

One cable entrance (14).

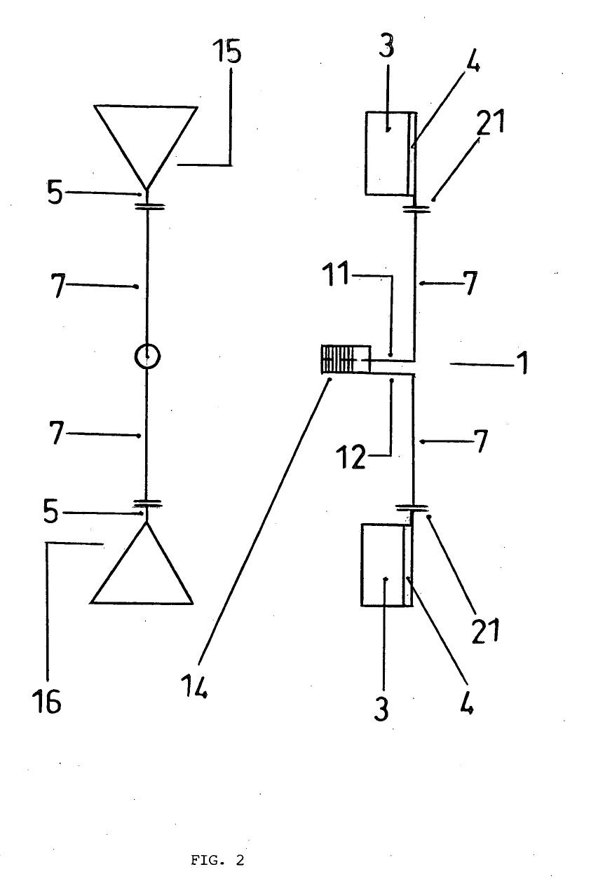

The electro technical arrangement of the components above to form the acting principle (1) can be different from the transmitting antenna (FIG. 1) to the receiving antenna (FIG. 2).

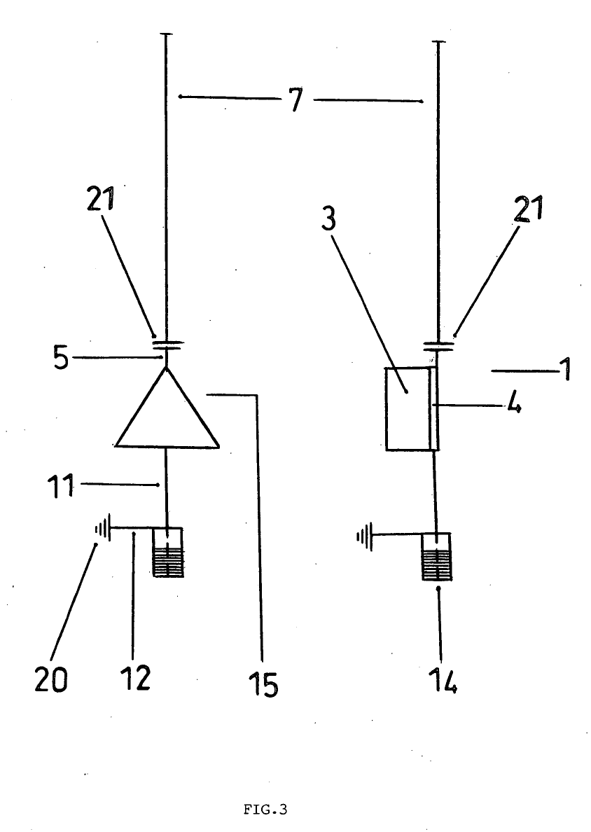

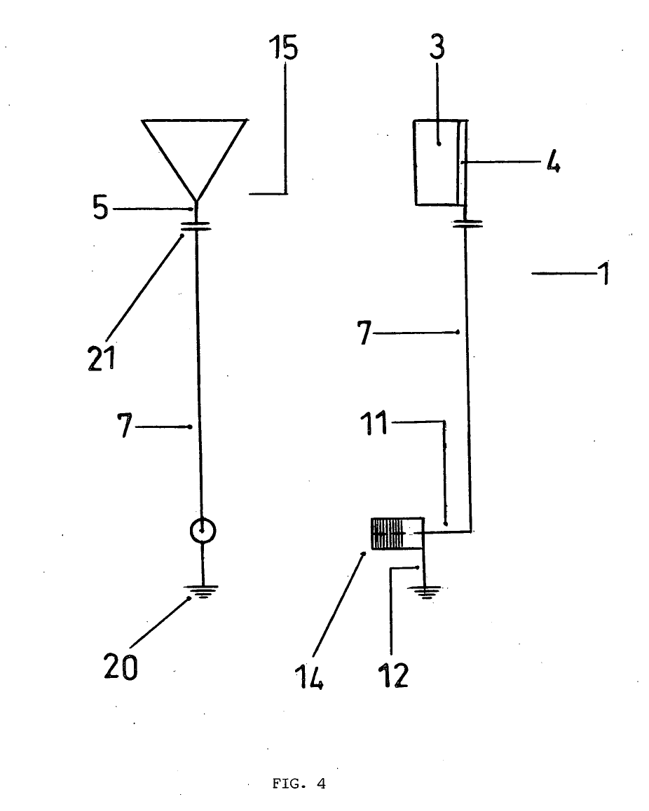

The improved special dipolar system can also be accurately reduced to only one half part (15) according to FIG. 3 and FIG. 4. In these cases, the cable entrance (14) is linked to an electric mass (20) which physical form can be variable.

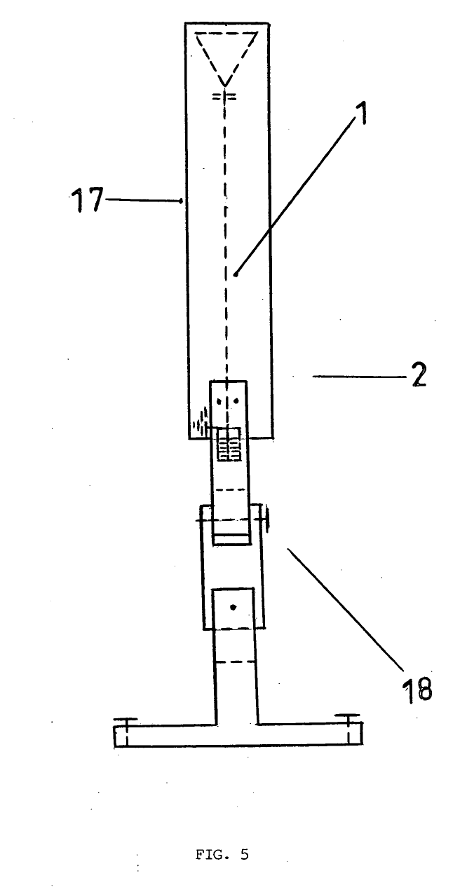

The above described acting principle (1) in FIG. 1, FIG. 2, FIG. 3 and FIG. 4 is then sealed, according to FIG. 5, in a filled insulating material box (17) that insulates the components from outside and seals together the different components of the acting principle (1). The sealed insulating box (17) containing the acting principle (1) is then raised on a tripod support (18) that is variable, adaptable, flexible, multidimensional rotary, and with the purpose to fix the antenna to function without disturbance.

The complete antenna (2) can also be small-scale devised and used as transducer that is put in the focus center of parabolic antennas. Such a transducer is very powerful to enhance performances of parabolic antennas.

What is claimed:

1. Device according to FIG. 5, in the sense that the complete antenna (2) is made with an acting principle (1) that can be conceived as described in FIG. 1, FIG. 2, FIG. 3 and FIG. 4 of the continuation device and sealed in a filled insulating material box (17) and raised on a tripod support (18) that is very variable, adaptable and flexible.

2. Device according to claim 1 and FIG. 1 and FIG. 2, in the sense that the acting principle (1) of the antenna can be made with:
a special dipolar system that is made with two identical parts (15) and (16). Each identical part (15) or (16) is made with a triangular or rectangular magnet (3), a triangular or rectangular semiconductor (4) containing a small conducing edge (5) in case of triangular semiconductor, a capacitor (21), a pointed conducting cable (7); and
a wave-pick-up-system made with two electric or coaxial cables (11) and (12), a cable entrance (14).

3. Device according to claim 1 and FIG. 3 and FIG. 4, in the sense that the acting principle (1) of the antenna can be made with:
a special dipolar system (15) that is made with a triangular or rectangular magnet (3), a triangular or rectangular semiconductor (4) containing a small conducting edge (5) in case of triangular semiconductor, a capacitor (21), a pointed conducting cable (7); and
a wave-pick-up-system made with two electric or coaxial cables (11) and (12), a cable entrance (14), an electric mass (20) which physical form can be variable.

4. Device according to claim 3, in the sense that the complete antenna (2) can be small-scale devised and used as transducer to enhance performances of parabolic antennas.

5. Device according to claim 2, in the sense that the conducting edge (5) of the triangular semiconductor can have variable form and can be extended to the rectangular semiconductor.

6. Device according to claim 3, in the sense that the conducting edge (5) of the triangular semiconductor can have variable form and can be extended to the rectangular semiconductor.

7. Device according to claim 2, in the sense that the magnet (3) and the semiconductor (4) can have variable form in general.

8. Device according to claim 3, in the sense that the magnet (3) and the semiconductor (4) can have variable form in general.

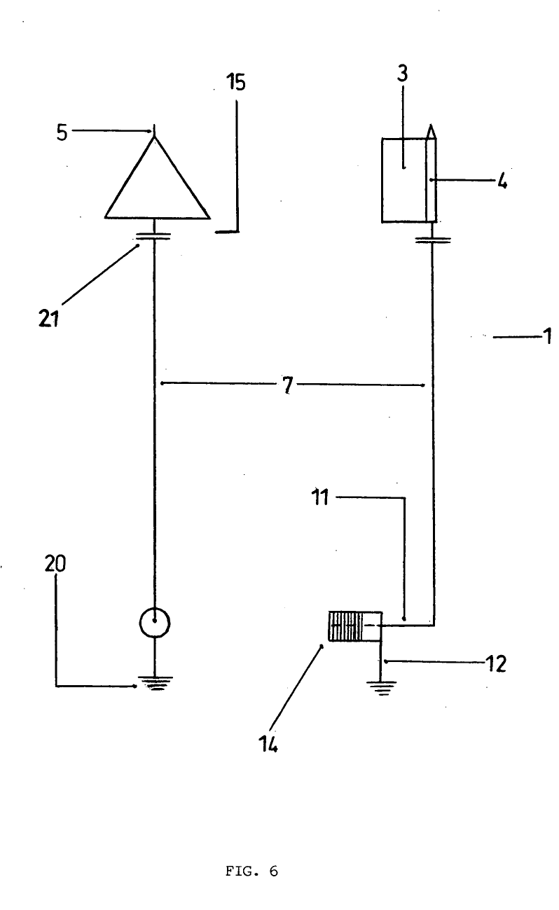

9. Device according to claim 2, in the sense that any reference to the acting principle (1) includes the case where the capacitor (21) and the pointed conducting metal support (7) can be linked to the semiconductor (4) by one of it non-pointed edge, as shown in FIG. 6.

10. Device according to claim 3, in the sense that any reference to the acting principle (1) includes the case where the capacitor (21) and the pointed conducting metal support (7) can be linked to the semiconductor (4) by one of it non-pointed edge, as shown in FIG. 6.
